(19) United States
(12) Patent Application Publication
(10) Pub. No.: US 2024/0024975 A1
(43) Pub. Date: Jan. 25, 2024

(54) METHOD FOR FLAME-CUTTING METAL WORKPIECES CONTAINING IRON, AND INSTALLATION FOR IMPLEMENTATION OF SAME

(71) Applicant: EMC CONCEPTION, Heillecourt (FR)

(72) Inventors: Pedrag KALUSEVIC, Nancy (FR); Cedric CLOVIS, Pierreville (FR)

(21) Appl. No.: 18/044,157

(22) PCT Filed: Sep. 7, 2021
(86) PCT No.: PCT/EP21/74618

§ 371 Date: Mar. 6, 2023

(30) Foreign Application Priority Data
Sep. 7, 2020 (FR) FR2009048

(51) Int. Cl. B23K 7/10

(52) U.S. Cl. CPC B23K 7/10; B23K 2103/02

(57) ABSTRACT

The flame-cutting method includes determining optimum parameters in terms of the pressure and flow rate of the fuel gas and of the oxygen and in terms of the position and speed of travel of the blowtorch relative to the workpiece that is to be flame-cut, and/or to the various phases of the flame-cutting method, and/or to the type of nozzle employed. The method includes executing at least one program controlling the gas and oxygen supply lines and the device for moving the blowtorch and storing the device for automatically running at least one program for controlling the gas and oxygen supply lines and the device for moving the blowtorch in memory. The method also includes automatically selecting at least one control program, the device for automatically sending control setpoints to the gas and oxygen supply lines, and the device for moving the blowtorch.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a method for flame-cutting metal workpieces containing iron, wherein each workpiece is subjected to a heating flame and a cutting jet applied by means of a nozzle connected to a blowtorch supplied by a pressurized fuel gas X supply line and a pressurized oxygen supply line.

### 2. Description of Related Art Including Information Disclosed Under 37 CFR 1.97 and 37 CFR 1.98

In a known manner, flame-cutting is an industrial method of cutting that oxidizes the iron contained in workpieces made of steel, and more generally of ferrous materials, through a jet of pure oxygen. Furthermore, this method incorporates an ignition phase, which is prior to the actual cutting phase, and which consists of heating the workpieces to be cut to their ignition temperature, in order to create a cutting priming point. In brief, flame-cutting equipment is designed such that, before exposing the workpieces to be cut to a cutting jet, a heating flame is generated in the nozzle connected to the blowtorch, through a mixture of fuel gas and oxygen, to subject the workpieces to a local temperature in the order of 1100° C. to 1300° C.

Furthermore, in order to guide the operators as they do their work, tables indicating the recommended values of certain cutting parameters, for types of nozzles or thicknesses of given parts, have been established. In practice, workers in charge of flame-cutting operations currently go by these reference data when carrying out adjustments on the tools that are used.

Although flame-cutting technology is well known per se, it has nonetheless been observed that, at present, the various equipment offered by manufacturers for its implementation have a certain number of drawbacks.

Thus, a first problem has been identified, related to the fact that conventional cutting installations all have substantially the same architecture, modeled on the one described above, and in which the fluid supply lines to the blowtorch are conventionally controlled by valves of the “on-or-off” type, with which any possible adjustment of the process proves to be difficult to implement.

In this regard, cutting defects, or even cutting delays, potentially as far as a total shutdown of cutting, as well as overconsumption of fluid, have been observed due to a very conventional way of proceeding based on a standardization of the adjustment parameters, in particular in terms of the pressure and flow rate of the fluids injected into the blowtorch, which take into account neither the steel grade of the workpiece to be cut, nor its thickness, despite the existence of reference tables. Indeed, it has been noted that the latter are not complete and require the operators to perform empirical adjustments for at least some parameters. Furthermore, external factors, such as e.g. the length of the hoses that the gas and oxygen supply lines comprise, premature wear of the nozzles, the presence of stacks of fittings, etc., can adversely affect the progress of the cutting operations and quality, despite the use of the charts.

In addition, the expansion systems of the expansion unit are traditionally configured manually, and are generally freely accessible to the operators, which is often the cause of unintended deviations of the settings of the pressure and flow rate parameters of the fluids as time goes by and as operators make changes. These deviations inevitably degrade the cutting performance and may result in the production of non-acceptable quality components from an industrial point of view.

The same applies to adjusting the blowtorch position relative to the workpiece that is to be flame-cut. When performed manually, this task is in fact unsuitable, haphazard, and inappropriate to an industrial environment, since it can lead to cutting problems that are difficult to solve, as their origin cannot be established with certainty. In addition, steel industry processes which involve the use of flame-cutting machines in order to cut workpieces of often large thickness do not conventionally allow the adjustment of the operating parameters of the blowtorch during processes. In other words, in this type of operation, the blowtorch must be adjusted in accordance with the charts before starting the cutting operations, regardless of the possibility of modification or action at a later time if necessary.

It has also been found that no conventional flame-cutting installation currently makes it possible to detect any quantified load losses, or blockages, that cause an unknown pressure delta between the setting and the reality, and to issue alerts if necessary.

Furthermore, in a conventional manner, the heating flame is supplied in an identical manner throughout the duration of the cutting process, i.e. during the priming phase and the cutting phase. However, concerning the flame-cutting technology itself, it has been observed that the heating requirements vary as the process progresses.

Document US 2011/0036461 addresses this problem and proposes, in order to avoid the problems related to possible spattering of molten metal in the direction of the nozzle, to implement after the ignition phase a first step of drilling the workpiece to be cut, by operating at a first pressure and/or a first oxygen flow rate and then to continue the cutting itself by operating at a second pressure and/or a second oxygen flow rate greater than the first pressure and/or the first oxygen flow rate.

Studies relating to the energy produced both by the blowtorch flame and by the flame-cutting reaction of iron have also shown that once the process has been launched, the energy of the latter is much greater than that of heating. Keeping the heating flame of the blowtorch at full power, with all that entails, consequently generates an excess of energy, which not only is likely to cause an untimely melting of the constituent material of the workpiece being flame-cut and therefore cause not only a quality defect, but also an overconsumption of fluids, which is detrimental to the method from an economic standpoint. Furthermore, problems related to operating at a generally constant pressure and/or flow rate throughout the cutting phase were also observed. However, no solution making it possible to automatically regulate both the fuel gas and the cutting oxygen, in real time, throughout a flame-cutting method, in accordance with the needs required by the workpiece in question, is available at the present time.

It should also be noted that, at the present time, no cutting installation is equipped with means for sending alerts concerning a possible malfunction or wear of its constituent elements, which may lead to overconsumption of gas and/or oxygen but especially to risks of explosion for the installation and the operators.

### BRIEF SUMMARY OF THE INVENTION

For all these observations, the aim of the present invention is to provide a solution that makes it possible to overcome all of the drawbacks observed through the implementation of conventional cutting installations so as to improve the quality of the cuts, allow better management of the consumption of fluids and more generally optimize production efficiencies and guarantee the safety of the operators.

For this purpose, the present invention relates to a method for flame-cutting metal workpieces containing iron, wherein each workpiece is subjected to a heating flame and a cutting jet applied by means of a nozzle connected to a blowtorch, said blowtorch being fed by a pressurized fuel gas supply line and a pressurized oxygen supply line and being controlled by means for moving the blowtorch relative to each workpiece that is to be flame-cut, characterized by the following steps:
The use of means for determining optimum parameters in terms of the pressure and flow rate of the fuel gas and of the oxygen and in terms of the position and speed of travel of the blowtorch relative to the workpiece that is to be flame-cut, according to the nature of the metal of which the workpiece is made, and/or to a thickness of the workpiece, and/or to the different phases of the flame-cutting method, and/or to the type of nozzle employed, and/or to a given temperature of the workpiece to be reached,
The execution of at least one program controlling the lines for supplying the pressurized fuel gas and for supplying the pressurized oxygen and the means for moving the blowtorch, said program providing control setpoints based on an implementation of the predetermined optimum parameters,
The storage in memory means of means for automatically running at least one program for controlling the lines for supplying the pressurized fuel gas and for supplying the pressurized oxygen and the means for moving the blowtorch,
The use of automatic-selection means for selecting at least one control program, and the use of means for automatically sending corresponding control setpoints to the lines for supplying the pressurized fuel gas and for supplying the pressurized oxygen and to the means for moving the blowtorch.

Depending on the case, the method according to the invention may comprise one or more of the following features:

To select a control program, the automatic running means are provided to the automatic-selection means for selecting at least one item of information from the group comprising the information relating to the nature of the metal constituting the workpiece that is to be flame-cut, to the thickness of the workpiece that is to be flame-cut, to the nature of a phase of the flame-cutting method, to the type of nozzle employed and to a temperature of the workpiece to be reached, by means of a user interface.

The pressure and/or the flow rate of the fuel gas and/or of the pressurized oxygen, and/or the temperature of the workpiece, and/or the position and/or the speed of the blowtorch relative to the workpiece, is recorded in real time, and the data recorded by the automatic running means are provided in order to verify matching between the data recorded and the control setpoints of the selected control program and, where appropriate, when the recorded data deviate(s) from a defined interval around the control setpoints, then an adjustment is applied to the pressure and/or to the flow rate of the fuel gas supply line, and/or of the pressurized oxygen supply line, and/or to the position and/or speed of movement of the blowtorch (3) relative to the workpiece that is to be flame-cut, so as to bring the corresponding data into the defined interval.

The means for sending an alert are activated when the data recorded in real time deviate from an interval defined around the control setpoints of the selected program.

The data received in real time are saved in the memory means of the automatic running means, and are used to activate means for automatic planning of maintenance operations.

The presence of a flame at the blowtorch is checked in an automated, real-time manner.

The invention also aims to propose an installation for implementing the flame-cutting method as described above, comprising at least one blowtorch provided with a flame-cutting nozzle, a pressurized oxygen supply line, and a pressurized fuel gas supply line, said lines each having a fluid inlet and at least two fluid outlets connected to said blowtorch to form a heating flame and a cutting jet, and being controlled by a set of adjustment members as well as means for moving the blowtorch relative to each workpiece that is to be flame-cut, characterized in that it comprises automatic running means designed to control, in an automated and remote manner, said lines for supplying pressurized fuel gas and supplying pressurized oxygen as well as said means for moving the blowtorch, on the basis of control setpoints that are based on the initially predetermined optimum parameters, and incorporated into at least one control program stored in memory means of said automatic running means.

Depending on the case, this installation may comprise one or more of the following features:

The running means are designed to remotely control the means for automatically adjusting said lines for supplying pressurized fuel gas and for supplying pressurized oxygen, as well as said means for moving the blowtorch, from data recorded in real time and compared to the control setpoints of the control program by data processing means included in the automatic running means.

It comprises means for detecting the position of the blowtorch relative to said workpiece that is to be flame-cut and means for measuring the temperature of the workpiece, while said lines for supplying pressurized fuel gas and for supplying pressurized oxygen each comprise a set of information sensors and the means for detecting the position of the blowtorch relative to said workpiece, and the information sensors are provided with means for transmitting data in real time to data receiving means comprised in said automatic running means.

The memory means of the automatic running means are designed to store means for processing the data measured by and received from the information sensors, and means for detecting the position of the blowtorch relative to said workpiece, said processing means consisting of at least one software application executed:
in a learning mode, prior to any flame-cutting operation, in order to record in said memory means at least one program for controlling the lines for supplying pressurized fuel gas and for supplying pressurized oxygen and the means for moving the blowtorch, said control program implementing control setpoints based on predetermined optimum parameters,
and subsequently, during a flame-cutting operation,
in an executive mode for activating means for automatically selecting a control program and causing the sending, by information transmission means comprised in the automatic running means, of corresponding control setpoints to receiving means comprised in the set of adjustment members and/or to receiving means comprised in the means for moving the blowtorch, and in a comparative mode for comparing the data measured by and received from the information sensors and the means for detecting the position of the blowtorch relative to said workpiece with the control setpoints of the selected control program, and activating the means for regulating the adjustment members and causing the sending, by the means for transmitting information, of control setpoints, to the receiving means comprised in the adjustment members and/or to the receiving means comprised in the means for moving the blowtorch, if at least one item of the measured and received data deviates from a defined interval around the control setpoints.

The information sensors comprise pressure sensors arranged in the immediate vicinity of the blowtorch.

The information sensors comprise flow rate sensors arranged upstream of an expansion unit, on the fluid inlet of each of the lines for supplying pressurized oxygen and for supplying pressurized fuel gas.

The information sensors comprise flow rate sensors integrated into an expansion unit and arranged on each of said fluid outlets, downstream of an adjustment member.

It comprises means for measuring the temperature of the workpiece,

The adjustment members comprise at least one proportional solenoid valve and/or expansion valve for each fluid supply line.

The automatic running means comprise or are connected to a user interface.

It comprises a programmable logic controller connected to the automatic running means by wired or wireless information transmission means.

It comprises automatic ignition means a distance away from the blowtorch.

It comprises means for detecting the presence of a flame in the blowtorch.

### BRIEF DESCRIPTION OF THE SEVERAL VIEWS OF THE DRAWINGS

The description is to be read in conjunction with the attached drawings.

FIG. 1 is a schematic view of an alternative embodiment of the installation according to the invention, comprising a single blowtorch and a pressure regulation loop.

FIG. 2 shows the electronic components of the installation of FIG. 1 in more detail.

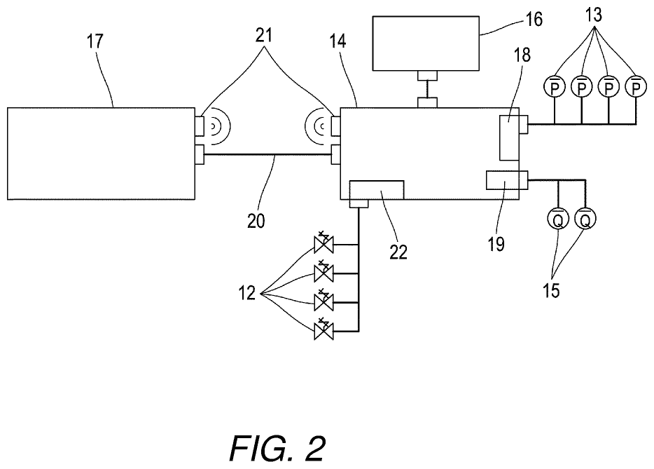

### DETAILED DESCRIPTION OF THE INVENTION

As indicated above, the present invention relates to a method and an installation 1 for the flame-cutting of metal workpieces 2 containing iron, such as more particularly workpieces made of non-alloyed or low-alloy steel, but also workpieces made of cast iron or stainless steel, etc.

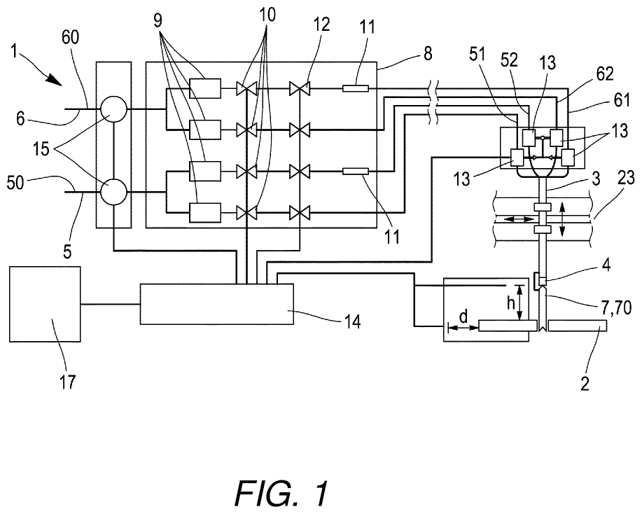

With reference to FIG. 1, the installation 1 conventionally comprises a blowtorch 3, provided with a flame-cutting nozzle 4, intended to be supplied with pressurized oxygen and/or a pressurized fuel gas, such as for example natural gas, respectively by means of a supply line 5 and a supply line 6, each connected to an expansion unit 8 which allows the fluids to be dispatched.

More precisely, the lines 5, 6 each have a fluid inlet 50, 60 connected to the expansion unit 8 and at least two fluid outlets 51, 52, 61, 62 connected to the blowtorch 3. In the illustrated example, the outlets 52, 61 of the lines 5, 6 are intended to form, in the blowtorch 3, the oxygen/fuel gas mixture that makes it possible to form the heating flame 7. The outlet 51 makes it possible to send the oxygen from the cutting jet 70 into the blowtorch 3, while the outlet 62 makes it possible to inject fuel gas intended to produce a heating flame that can, where appropriate, bolster the cutting jet during the cutting phase.

Furthermore, the expansion unit 8 conventionally integrates expansion members 9 placed on the fluid outlets 51, 52, 61, 62, as well as adjustment members, such as, for example, solenoid valves 10 of the “on-or-off” type and a set of proportional solenoid valves 12. Each of the outlets 52, 61 is also equipped with a flame barrier 11, making it possible to stop the flame if necessary.

It should also be noted that the installation 1 further comprises automatic ignition means remote from the blowtorch 3, allowing it to be used totally safely. In addition, means 23 for moving the blowtorch 3 making it possible to place it at an optimal position with respect to the workpiece 2, then to move it along the workpiece as the flame-cutting method proceeds at a certain speed, at a constant or variable height. It is specified that the optimal position is understood both in terms of height h of the blowtorch 3 with respect to the workpiece 2, and distance d on the edge of the latter when the process is started and throughout the process.

The installation 1 further comprises automatic running means, housed in a housing 14, and designed to remotely control, in an automated manner, all of the constituent elements of the installation 1, on the basis of the control setpoints integrated into at least one control program stored in memory means of the automatic running means, and based on the initially predetermined parameters.

In other words, according to the invention, the implementation of the installation 1 is done through a selection, carried out by automatic selection means, of at least one control program allowing very fine control setpoints to be sent to the supply lines for pressurized fuel gas 6 and pressurized oxygen 5 as well as to the means 23 for moving the blowtorch 3.

As indicated above, the control setpoints specific to the selected control program are based on a prior determination of the set of optimum parameters for the operation considered. Advantageously, these optimum parameters relate to the pressure and flow rate of fuel gas and oxygen in their respective supply lines 5, 6, as well as the position and speed of movement of the blowtorch 3 relative to the workpiece 2 to be flame-cut. They also correspond to the values leading to the best results for a given type of metal constituting the workpiece 2, and/or a given thickness of the workpiece 2, and/or a given time instant t of the flame-cutting method, and/or a given type of nozzle 4, and/or a desired temperature of the workpiece 2.

Under such circumstances, contrary to conventional flame-cutting methods, the constituent elements of the installation 1 are not directly controlled by the operators, but through a control program, determined by the automatic selection means on the basis of the automatic running means 14 previously being provided, via a user interface 16, with at least one item of information from the group comprising the information relating to the nature of the metal constituting the workpiece 2 to be flame-cut, to the thickness of the workpiece 2 to be flame-cut, to a given instant of the method for flame-cutting, to the type of nozzle 4 used, or to a given temperature of the workpiece 2 to be maintained.

Thus, the instructions transmitted to the different constituent elements of the installation 1 will rely on a prior determination of the set of optimal parameters specifically suited to a given situation and not on a sometimes arbitrary choice performed by an operator.

It is specified that for this purpose, the memory means of the automatic running means 14 are designed to store at least one software application executed in a learning mode, prior to any flame-cutting operation, in order to record, in said memory means, at least one control program as described above, and subsequently, during a flame-cutting operation, in an executive mode, to activate the means for selecting a control program and to cause the sending, by information transmission means 22 comprised in the automatic running means 14, of control setpoints for the selected program to receiving means comprised in the valves 10, 12 and/or to receiving means comprised in the means 23 for moving the blowtorch 3.

It should be noted that in the illustrated variant embodiment, the installation 1 comprises a programmable logic controller 17 allowing an operator to enter, as indicated above, at least one item of information relating to the planned flame-cutting operation, namely at least one item of information relating to the nature of the metal constituting the workpiece 2 to be flame-cut, or to the thickness of the workpiece 2 to be flame-cut, or to a given instant of the method for flame-cutting, to the type of nozzle 4 employed, or to the temperature of the workpiece 2 to be preserved throughout the process. The information that is input will then be transmitted to the automatic running means 14 connected to the logic controller 17 by wired or wireless information transmission means 21, then processed by the software application. According to one alternative, in this regard, the installation 1 may comprise a user interface 16 connected to or integrated into the housing containing the automatic running means 14.

Furthermore, the present invention also provides the possibility of regulating in real time, at any moment and automatically, all the constituent elements of the installation 1.

For this purpose, in the illustrated variant embodiment, the pressurized oxygen and fuel gas supply lines 5, 6 each comprise a pressure sensor 13 arranged on their outlets 51, 52, 61, 62, in the immediate vicinity of the blowtorch 3, as well as a flow rate sensor 15 arranged on their respective inlets 50, 60, upstream from the expansion unit 8. Likewise, the means 23 for moving the blowtorch 3 comprise means for detecting the position of the blowtorch 3. Furthermore, the pressure 13 and flow rate 15 sensors as well as the means for detecting the position of the blowtorch 3 are provided with means for transmitting data in real time to data receiving means 18, 19 that the automatic running means 14 comprise.

Furthermore, in this objective, the software application described above is also designed to be executed in a comparative mode for comparing the data measured by and received from the pressure and flow sensors 13, 15 and the means for detecting the position of the blowtorch 3 relative to the workpiece 2 with the control setpoints of the selected control program, and activating regulating means in order to cause the sending, by the information transmission means 22, of regulation setpoints to the receiving means that the valves 10, 12 and/or to the receiving means included in the means 23 for displacement of the blowtorch 3 comprise, if at least one item of the measured and received data deviates from a defined interval around said control setpoints.

In other words, the method according to the invention allows automatic and real-time regulation of the pressure and flow rate of the fluids circulating in the supply lines 5, 6, as well as any automatic repositioning, for example by horizontal and/or vertical translation, of the blowtorch 3 to an optimal position relative to the workpiece 2. Likewise, a change in the speed of movement of the blowtorch 3 relative to the workpiece 2 can be ordered.

It should also be noted that the installation according to the invention can also be equipped with means for measuring the temperature of the workpiece 2 at each instant of the flame-cutting method, these means being designed to transmit and receive data to and from the automatic running means 14. Thus, their implementation also allows a correction of the installation 1 which takes into account a possible inadvertent change of the temperature of the workpiece 2 during flame-cutting, in order to act on the supply of heating gas or of cutting oxygen, whichever the case may be.

By virtue of the structure that has just been described, the installation according to the invention allows automated control as well as fine and automated regulation of a flame-cutting method, through the implementation of means for determining the set of optimum working parameters for a given operation, and automation of the management of adjustments to the heating and cutting of the blowtorch 3, in order to result in suitable and ideal cutting regardless of the type of ferrous metal of which the workpiece 2 is made, the thickness of the latter, the type of nozzle 4 used or the phase of the flame-cutting method. For this purpose, the installation 1 has a closed control loop, making it possible to set a setpoint to a fluid supply line 5, 6, while data sensors allow a comparison between the setpoint data and the data recorded in real time, in order to authorize a correction as a result and in real time of the constituent elements of the installation 1.

The flow rate sensors 15, installed upstream from the expansion unit 8, on each fluid inlet 50, 60 also advantageously make it possible to provide the consumption of the installation 1 in real time and a triggering of means for sending alerts if applicable.

The assembly of the pressure sensors 13 and flow sensors 15 also allow the triggering of alerts when abnormal values, likely to be caused by wear in the installation 1, such as leaks, blockages, or a damaged nozzle, are detected at the control housing 14. These alerts advantageously allow the rapid intervention of the operators. The method according to the invention further provides for recording the data received in real time in the memory means of the automatic running means 14 and for using them to activate means for automatic planning of preventive maintenance operations, thus increasing the safety of the installation 1.

Means for real-time detection of the presence of a flame in the blowtorch 3 are also provided, which also help contribute to improving the safety of the installation 1.

In other words, by virtue of its architecture, the installation 1 according to the invention offers a response to the aforementioned drawbacks regarding current equipment and methods for flame-cutting. It allows automatic control and accurate correction, taking into account the type of ferrous metal to be cut, in particular in terms of grade of steel or thickness, but also the nature of the nozzle 4 used to cut it, or even the temperature of the workpiece to be reached, and the different phases of the flame-cutting method. It also makes it possible to optimize the height of the blowtorch 3, to keep the settings from drifting over time given that the operators can no longer modify them and that they are adjusted automatically if necessary to comply with the charts. The installation according to the invention also makes it possible to vary the heating requirements as the flame-cutting process is carried out. Furthermore, the load losses of the network are taken into account since the flow rate sensors 15 and pressure sensors 13 are positioned as close as possible to the material and the wear of the equipment is also managed by the controller. This has the direct effect of acting on the quality of the semi-products created, of affording material savings when cutting as well as reduced consumption of the gases employed.

It should also be noted that the structure of the installation according to the invention, although having been described in connection with a single blowtorch 3, may be suitable for use with a plurality of blowtorches 3 and have the same advantages.

1. A method for flame-cutting metal workpieces containing iron, wherein each workpiece is subjected to a heating flame and a cutting jet applied by a nozzle connected to a blowtorch, said blowtorch being fed by a pressurized fuel gas supply line and a pressurized oxygen supply line and being controlled by means for moving the blowtorch relative to each workpiece that is to be flame-cut, characterized by the following steps:
determining optimum parameters in terms of the pressure and flow rate of the fuel gas and of the oxygen and in terms of the position and speed of travel of the blowtorch relative to the workpiece that is to be flame-cut, according to the nature of the metal of which the workpiece is made, and/or to a thickness of the workpiece, and/or to the different phases of the flame-cutting method, and/or to the type of nozzle employed, and/or to a given temperature of the workpiece to be reached,
executing at least one program controlling the pressurized fuel gas supply line and the pressurized oxygen supply line and the means for moving the blowtorch, said program providing control setpoints based on an implementation of the predetermined optimum parameters,
storing in memory means of means for automatically running at least one program for controlling the pressurized fuel gas supply line and the pressurized oxygen supply line and the means for moving the blowtorch, and
selecting at least one control program, and the use of means for automatically sending corresponding control setpoints to the pressurized fuel gas supply line and the pressurized oxygen supply line and to the means for moving the blowtorch.

2. The method for flame-cutting, according to claim 1, wherein the step of selecting the control program is comprised of: providing the automatic running means to the automatic-selection means for selecting at least one item of information from the group comprising the information relating to the nature of the metal of which the workpiece that is to be flame-cut is made, to the thickness of the workpiece that is to be flame-cut, to the nature of a phase of the flame-cutting method, to the type of nozzle employed and to a temperature of the workpiece to be reached, by means of a user interface.

3. The method for flame-cutting, according to claim 1, further comprising the steps of: recording the pressure and/or the flow rate of the fuel gas and/or of the pressurized oxygen, and/or the temperature of the workpiece, and/or the position and/or the speed of the blowtorch relative to the workpiece, in real time, and providing the data recorded by the automatic running means in order to verify matching between the data recorded and the control setpoints of the selected control program and, where appropriate, when the recorded data deviate(s) from a defined interval around the control setpoints, then an adjustment is applied to the pressure and/or to the flow rate of the fuel gas supply line, and/or of the pressurized oxygen supply line, and/or to the position and/or speed of movement of the blowtorch relative to the workpiece that is to be flame-cut, so as to bring the corresponding data into the defined interval.

4. The method for flame-cutting, according to claim 3, further comprising the step of: activating a means for sending an alert when the data recorded in real time deviate from an interval defined around the control setpoints of the selected program.

5. The method for flame-cutting, according to claim 3, further comprising the step of: saving the data received in real time in the memory means of the automatic running means and are used to activate means for automatic planning of maintenance operations.

6. The method for flame-cutting, according to claim 1, further comprising the step of: checking presence of a flame at the blowtorch in an automated and real-time manner.

7. An installation for flame-cutting metal workpieces containing iron, comprising:
at least one blowtorch provided with a flame-cutting nozzle,
a pressurized oxygen supply line, and
a pressurized fuel gas supply line, said lines each having a fluid inlet and at least two fluid outlets connected to said blowtorch to form a heating flame and a cutting jet, and being controlled by
a set of adjustment members as well as
means for moving the blowtorch relative to each workpiece that is to be flame-cut, characterized in that it comprises
automatic running means designed to control, in an automated and remote manner, said pressurized fuel gas supply line- and pressurized oxygen supply line as well as said means for moving the blowtorch, on the basis of control setpoints that are based on the initially predetermined optimum parameters, and incorporated into at least one control program stored in memory means of said automatic running means.

8. The installation, according to claim 7, wherein the running means are designed to remotely control the means for automatically adjusting said pressurized fuel gas supply line and pressurized oxygen supply line, as well as said means for moving the blowtorch, from data recorded in real time and compared to the control setpoints of the control program by data processing means included in the automatic running means.

9. The installation, according to claim 8, further comprising:
means for detecting the position of the blowtorch relative to said workpiece that is to be flame-cut, and
means for measuring the temperature of the workpiece,
wherein said lines for supplying pressurized fuel gas and for supplying pressurized oxygen each comprise a set of information sensors, and
wherein the means for detecting the position of the blowtorch relative to said workpiece, and the information sensors are provided with means for transmitting data in real time to data receiving means comprised in said automatic running means.

10. The installation, according to claim 9, wherein the memory means of the automatic running means are designed to store means for processing the data measured by and received from the information sensors, and the means for detecting the position of the blowtorch relative to said workpiece, said processing means consisting of at least one software application executed:
in a learning mode, prior to any flame-cutting operation, in order to record in said memory means at least one program for controlling the pressurized fuel gas supply line and pressurized oxygen supply line and the means for moving the blowtorch, said control program implementing control setpoints based on predetermined optimum parameters,
and subsequently, during a flame-cutting operation,
in an executive mode for activating means for automatically selecting a control program and causing the sending, by information transmission means comprised in the automatic running means, of corresponding control setpoints to receiving means comprised in the set of adjustment members and/or to receiving means comprised in the means for moving the blowtorch, and in a comparative mode for comparing the data measured by and received from the information sensors and the means for detecting the position of the blowtorch relative to said workpiece with the control setpoints of the selected control program, and activating the means for regulating the adjustment members and causing the sending, by the means for transmitting information, of control setpoints, to the receiving means comprised in the adjustment members and/or to the receiving means comprised in the means for moving the blowtorch, if at least one item of the measured and received data deviates from a defined interval around the control setpoints.

11. The installation, according to claim 9, wherein the information sensors comprise pressure sensors arranged in the immediate vicinity of the blowtorch.

12. The installation according to claim 9, wherein the information sensors comprise flow rate sensors arranged upstream of an expansion unit, on the fluid inlet of each of the pressurized oxygen and fuel gas supply lines.

13. The installation, according to claim 9, wherein the information sensors comprise flow rate sensors integrated into an expansion unit and arranged on each of said fluid outlets, downstream of an adjustment member.

14. The installation, according to claim 7, further comprising: means for measuring the temperature of the workpiece.

15. The installation, according to claim 7, wherein the adjustment members comprise at least one solenoid valve and/or expansion valve for each fluid supply line.

16. The installation, according to claim 7, wherein the automatic running means comprise or are connected to a user interface.

17. The installation, according to claim 7, further comprising: a programmable logic controller connected to the automatic running means by wired or non-wired information transmission means.

18. The installation, according to claim 7, further comprising: automatic ignition means remote from the blowtorch.

19. The installation, according to claim 7, further comprising: means for detecting the presence of a flame in the blowtorch.
